(19) United States
(12) Patent Application Publication
(10) Pub. No.: US 2020/0348144 A1
(43) Pub. Date: Nov. 5, 2020

(54) METHOD AND DISPLAY SYSTEM FOR DISPLAYING OUTPUT DATA

(71) Applicant: AUDI AG, Ingolstadt (DE)

(72) Inventor: Andreas ROTH, Kipfenberg/Böhming (DE)

(73) Assignee: AUDI AG, Ingolstadt (DE)

(21) Appl. No.: 16/607,998

(22) PCT Filed: Jan. 4, 2019
(86) PCT No.: PCT/EP2019/050131

§ 371 Date: Oct. 24, 2019

(30) Foreign Application Priority Data
Jan. 27, 2018 (DE) 10 2018 200 669.5

(51) Int. Cl. G01C 21/36; B60K 35/00; B60R 13/10; G07C 5/08

(52) U.S. Cl. CPC G01C 21/367; B60K 35/00; B60R 13/10; G07C 5/0816; B60K 2370/152; B60K 2370/16; B60K 2370/12; B60K 2370/5911; B60K 2370/797

(57) ABSTRACT

The disclosure relates to a method for displaying output data, wherein the output data includes motor-vehicle-side data of a motor vehicle which is displayed via a placard, wherein the motor-vehicle-side data is represented by a color coding of the placard and approval data of the motor vehicle, said method comprising the following steps:
providing a display device for displaying the output data;
detecting the motor-vehicle-side data of the motor vehicle by means of a detection device;
determining the color coding of the placard by means of a control device based on the detected motor-vehicle-side data;
displaying a placard surface of the placard in a display region of a display surface of the display device, wherein the placard surface has the color coding; and
receiving a release signal for displaying the approval data in a predetermined region of the placard surface of the placard.

### TECHNICAL FIELD

The application relates to a method for displaying output data.

### BACKGROUND

It is known from the prior art that, by means of a display device, information is displayed in a motor vehicle, for example, in the form of a navigation map, for a driver, and outside the motor vehicle, it is displayed, for example, in the form of a taxi sign, for other road users.

For example, DE 10 2016 001 191 A1 describes a display device for a motor vehicle for displaying image contents. For that purpose, the display device has a display surface for displaying image information, and a control device that provides a control signal for controlling the display surface. With the display surface, it is further possible to display an identification symbol as image information, wherein the identification symbol is displayed on the basis of the control signal. The control signal contains information about the point in time, at which the identification symbol on the motor vehicle is supposed to be visible from the outside.

DE 20 2010 006 825 U1 discloses a motor vehicle license plate. The license plate has at least one electronic display means for displaying a single or multi-line letter and/or number combination of a license plate number. Furthermore, the license plate comprises at least one display control unit which is connectable to the display means, wherein the depiction of the font and the layout on the display means corresponds to a country-specific license plate.

Furthermore, from DE 10 2008 059 147 A1 , a motor vehicle with a hybrid drive is known, which has a first drive unit and a second lower-emission drive unit, wherein the motor vehicle can be driven in travel mode in different operating modes of the hybrid drive, at least either by the first drive unit or by the second, lower-emission drive unit. Furthermore, the motor vehicle has a display device visible in travel mode from outside the motor vehicle for displaying the current operating mode of the hybrid drive.

Such display devices have a particularly complex design and are expensive to operate. Furthermore, such display devices are impossible or very difficult to adapt or update once their intended use is determined.

### BRIEF DESCRIPTION OF THE DRAWINGS

FIG. 1 shows a schematic depiction of a method for displaying output data in a flow chart.

FIG. 2 shows a schematic depiction of a display system for displaying the output data.

FIG. 3 shows a schematic depiction of individual components of the display system.

### DETAILED DESCRIPTION

The application relates to a method for displaying output data. The application also relates to a display system for displaying output data, which can be operated by the method according to the application.

It is known from the prior art that, by means of a display device, information is displayed in a motor vehicle, for example, in the form of a navigation map, for a driver, and outside the motor vehicle, it is displayed, for example, in the form of a taxi sign, for other road users.

For example, DE 10 2016 001 191 A1 describes a display device for a motor vehicle for displaying image contents. For that purpose, the display device has a display surface for displaying image information, and a control device that provides a control signal for controlling the display surface. With the display surface, it is further possible to display an identification symbol as image information, wherein the identification symbol is displayed on the basis of the control signal. The control signal contains information about the point in time, at which the identification symbol on the motor vehicle is supposed to be visible from the outside.

DE 20 2010 006 825 U1 discloses a motor vehicle license plate. The license plate has at least one electronic display means for displaying a single or multi-line letter and/or number combination of a license plate number. Furthermore, the license plate comprises at least one display control unit which is connectable to the display means, wherein the depiction of the font and the layout on the display means corresponds to a country-specific license plate.

Furthermore, from DE 10 2008 059 147 A1, a motor vehicle with a hybrid drive is known, which has a first drive unit and a second lower-emission drive unit, wherein the motor vehicle can be driven in travel mode in different operating modes of the hybrid drive, at least either by the first drive unit or by the second, lower-emission drive unit. Furthermore, the motor vehicle has a display device visible in travel mode from outside the motor vehicle for displaying the current operating mode of the hybrid drive.

Such display devices have a particularly complex design and are expensive to operate. Furthermore, such display devices are impossible or very difficult to adapt or update once their intended use is determined.

Therefore, the present application addresses the problem of providing a method and a display system for displaying output data, which is particularly easy to operate and is operable in a particularly flexible manner, especially with regard to an update of the output data.

Said problem is solved by a method for displaying output data and by an associated display system having the features of the independent patent claims. Advantageous embodiments with expedient and non-trivial developments of the application are specified in the dependent claims.

In the method for displaying output data, the output data includes motor-vehicle-side data of a motor vehicle, which is displayed via a placard. In other words, the placard can represent or be linked to the motor-vehicle-side data of the output data. “Placard” refers particularly to a display element provided with predetermined information. For example, the placard can be designed in the form of a plate.

The motor-vehicle-side data is further represented by a color coding of the placard and approval data of the motor vehicle. “Color coding” refers particularly to an identification color which fills the placard. Preferably, the placard can comprise the colors red or green or yellow. “Approval data” refers particularly to the data of the motor vehicle, with which the motor vehicle is registered. For example, the approval data can include data stored in a vehicle registration of the motor vehicle.

In the method, a display device for displaying or outputting the output data is provided. The display device is designed, for example, as an e-paper or electronic paper, particularly as an LCD. By means of the display device, the placard can be displayed or superimposed on a display surface of the display device.

In a further method step, the motor-vehicle-side data of the motor vehicle is detected by means of a detection device. For this purpose, the detection device can comprise particularly one or more measuring devices and/or one or more sensors. Subsequently, the color coding of the placard is determined by means of a control device based on the detected motor-vehicle-side data. For this purpose, the detection device can be designed to communicate or transmit the detected motor-vehicle-side data to the control device or to provide the control device with said motor-vehicle-side data. The control device can then be designed to evaluate and/or analyze the detected motor-vehicle-side data. Depending on the detected motor-vehicle-side data, the control device can then select or specify a color coding of the placard. The control device is particularly designed to design the placard on the basis of the motor-vehicle-side data. For example, a predetermined value interval can be stored for a respective color of the color coding. Depending on the value interval, into which the detected motor-vehicle-side data falls, the color assigned to the value interval is determined or selected.

In a subsequent method step, a placard surface of the placard, which has the color coding, is displayed in a display region of a display surface of the display device. For this purpose, pixels can be displayed on the display surface of the display device, which, at least partially, i.e., completely or partially, depict or display or fill the placard, i.e., the placard surface, in color. The placard is thus displayed particularly electronically and is particularly not designed as a sticker.

Subsequently, a release signal is received for displaying the approval data in a predetermined region of the placard surface of the placard, and the display device for displaying the placard, which has the color coding and the approval data, is actuated. In other words, the approval data cannot be displayed until the release signal has been received. In order to display the approval data, the control device can acquire or receive the approval data, or the approval data can already be stored in the control device, particularly in a memory of the control device. Additionally or alternatively, the approval data can initially also be detected by the detection device. The approval data can be displayed or superimposed in the predetermined region or section of the placard surface. The display of the placard, particularly the color coding and the approval data, is preferably effected automatically.

The placard surface can also have a predetermined shape, such as a round or rectangular or oval or polygonal shape. For example, the outlines of the placard, such as the shape, can initially be displayed with a neutral color, such as black or white. At first, a standard placard can preferably be displayed, which is filled with the color coding and the approval data after the detection of the motor-vehicle-side data.

Depending on the motor-vehicle-side data of the motor vehicle that is detected, the placard can be filled accordingly. Furthermore, the placard can be used to provide a standard placard for a service life of the motor vehicle, which can be controlled variably and/or process-reliably and/or color adjustable. Furthermore, the placard can be adapted with respect to a change in the motor-vehicle-side data. By providing the display device, a simplified handling for attaching a placard is possible. Furthermore, the automatic display of the placard results in time and/or cost savings for the user or owner of the motor vehicle, and in addition, a double use and/or an abuse of the placard can be reduced by linking the display of the placard with the detected motor-vehicle-side data.

An advantageous embodiment provides that emission values of the motor vehicle are detected as motor-vehicle-side data, wherein the color coding of the placard differs on the basis of the detected emission values of the motor vehicle. In other words, the motor-vehicle-side data can include detected emission values of the motor vehicle, which determine the color coding of the placard. In other words, the placard can have a different color, depending on the emission values detected. Preferably, values of an exhaust emission of the motor vehicle are determined as the emission values of the motor vehicle. Particularly preferably, values of nitrogen oxides or NOx, particularly preferably nitrogen dioxide, are determined. Preferably, the placard is designed as an environmental placard or a fine-particles placard. For detecting the emission values of the motor vehicle, the detection device can, for example, have at least one lambda probe. Additionally or alternatively, the detection device can comprise one or more measuring devices which are arranged in the drive train, particularly on the engine and/or on the transmission of the motor vehicle. As a result, emission values of the motor vehicle can be determined in a particularly simple and reliable manner.

In particular, the color coding of the placard differs on the basis of the detected emission values of the motor vehicle. The emission values can be assigned to emission classes or emission groups. The emission values are preferably subdivided into three emission classes. Each emission class is preferably assigned a predetermined color. For example, the placard is given a green color if the emission values fall into emission class 4, a yellow color if the emission values fall into emission class 3, or a red color if the emission values fall into emission class 2.

Advantageously, a license plate number is displayed as approval data of the motor vehicle. The motor-vehicle-side data thus comprises particularly the approval data, which includes the motor vehicle license plate, and emission values of the motor vehicle. In particular, the emission values of the motor vehicle are output as a color coding of the placard, and the motor vehicle license plate is output on a predetermined region of the placard surface. “Motor vehicle license plate” refers particularly to a vehicle registration number or a license plate of the motor vehicle. In this case, the motor vehicle license plate particularly comprises a distinguishing sign, preferably one to three letters, for example, IN, and an identification number, preferably one or two letters and up to four digits, for example, XY 1234. The motor vehicle license plate is then preferably displayed or superimposed in the predetermined region of the placard surface of the placard.

According to an advantageous development, it is provided that the release signal is received after input of a release code. The release signal is preferably output by a server device, particularly a vehicle-external server device, in response to the input of the release code. The server device is preferably a server device of a registration office and/or a server device of a technical control board, such as the German Technical Control Board (TÜV). Additionally or alternatively, the release code can be issued or provided by the server device. For example, the release code can be transmitted to a portable mobile terminal of the owner of the motor vehicle. Alternatively, the release code can be forwarded to the owner of the motor vehicle either manually or on paper. If the owner is provided with the release code, said owner can enter or type the release code, for example, into an input device of the motor vehicle. The control device of the motor vehicle can then be designed to output or transmit a signal to the server device which is then designed to verify the entered release code. If the release code matches, for example, a release code stored in the server device, which is assigned particularly to the motor vehicle, then the server device can output the release signal.

The “release code” is particularly a number and/or letter combination. Preferably, the release code is temporally limited. In other words, the validity of the release code can be limited temporally. For example, it can be provided that the server device is designed to allow the release code only for a predetermined timeframe when the release code is created. Accordingly, when the release code is issued, the server device can be designed to communicate the release code and the timeframe allocated to the release code. Due to the temporal limitation of the release code, misuse or disclosure can be prevented or prohibited. This can increase security when the release code is provided.

In addition, a vehicle identification number and/or a chassis number and/or an emission key number and/or an engine type, particularly diesel or Otto or g-tron or e-tron or h-tron, and/or a vehicle design and/or a first registration of the motor vehicle and/or a current date can be detected as motor-vehicle-side data, particularly for displaying the placard. Additionally or alternatively, the motor-vehicle-side data can be transmitted to the server device, particularly for obtaining the release code.

A further advantageous embodiment provides that, in case of a change of the motor-vehicle-side data, a notification is output by means of an output device. The change of the motor-vehicle-side data can be detected by the control device. If, for example, it is determined by the control device that the motor vehicle's emission values, to which a color coding is assigned, change in such a way that the color coding would change, the control device can be designed to actuate the output device. In other words, the control device can be designed to actuate the output device such that information is output by means of the output device, which indicates a change in the motor-vehicle-side data. If, for example, it is determined by the control device that the approval data, such as the license plate of the motor vehicle, changes, the control device can be designed to actuate the output device. In other words, the control device can actuate the output device in case of a license plate change of the motor vehicle. For example, the output device can be designed as a multimedia device of the motor vehicle, which, for example, comprises a screen or a display or a loudspeaker. For example, a lettering can be displayed by means of the display of the output device. For example, this lettering can display “Change of approval data” or “Placard invalid.” Alternatively or additionally, this information can also be output acoustically by means of the loudspeaker. As a result, the driver or owner of the motor vehicle is provided particularly quickly and reliably with a status update on a timeliness and validity of the displayed placard.

For example, an update code for updating the color coding of the placard and/or the approval data can be requested when the notification is output. Preferably, the control device of the motor vehicle can be designed to output a request message to the server device upon detection of a change in the motor-vehicle-side data, particularly the emission values and/or the approval data. As a response to the request message, the server device can subsequently be designed to output or transmit to the motor vehicle the update code which is preferably limited temporally. As with the release code, the update code can use the release signal to display the new or changed approval data. In this case, the release signal can be received, particularly by the server device, after input of the update code. The color coding of the placard and/or the changed approval data can then preferably be updated automatically.

Advantageously, the output data further comprises at least one vignette and/or a parking pass and/or a parking clock, wherein the vignette and/or the parking pass and/or the parking clock are displayed in a further display region of the display surface of the display device. In other words, at least one vignette and/or a parking pass and/or a parking clock can be displayed in addition to the placard on the display surface of the display device. “Vignette” refers particularly to a revenue stamp for the use of predetermined roads, particularly highways, in predetermined countries, such as Switzerland or Austria. “Parking pass” refers particularly to a parking sticker. “Parking clock” refers particularly to a parking disc. If, for example, the driver of the motor vehicle has purchased a vignette or a parking pass, a request can be transmitted or provided to the driver, particularly to a mobile terminal of the driver, or to the output device of the motor vehicle. For example, the further release code can be provided by a further server device. The driver can enter the further release code into the input device of the motor vehicle, particularly via a user interface of the input device, wherein the input device is coupled to the control device. The input device is designed, for example, as a touchscreen. The control device can subsequently actuate the display device to display or superimpose the vignette or the parking pass in the further display region of the display surface.

According to an advantageous development, a current position of the motor vehicle and/or a predetermined travel route is detected, wherein the further release code for displaying the vignette is requested on the basis of the current position of the motor vehicle and/or a predetermined travel route of the motor vehicle, wherein the vignette is displayed as soon as the further release code is received or entered via a user interface. Thus, the vignette can also be provided automatically on the basis of a current position of the motor vehicle. Depending on the current position and/or the predetermined travel route of the motor vehicle, the control device can be designed to actuate the display device to display the vignette. For this purpose, one or more vignettes, which are assigned to the corresponding countries, can be stored in the control device, particularly in a memory of the control device. In order to activate the corresponding vignette, the control device can be designed to detect the further release code.

Advantageously, the release signal and/or the release code and/or the further release code is communicated or transmitted via a radio link, particularly via a mobile phone connection and/or a WLAN connection and/or a Bluetooth connection.

The application also includes a display system for displaying output data, wherein the output data includes motor-vehicle-side data of a motor vehicle, which can be displayed via a placard, wherein the motor-vehicle-side data is represented by a color coding of the placard and approval data of the motor vehicle. The display system includes a display device designed to display the output data. The display system further has a detection device which is designed to detect the motor-vehicle-side data of the motor vehicle. The display system further comprises a control device which is designed to determine the color coding of the placard on the basis of the detected motor-vehicle-side data. The display device is further designed to display a placard surface of the placard in a display region of a display surface of the display device which has the color coding. The control device is further designed to receive a release signal for displaying the approval data in a predetermined region of the placard surface of the placard and, upon receiving the release signal, to actuate the display device to display the placard, which has the color coding and the approval data.

According to an advantageous embodiment, the display device is arranged in a predetermined region of a windshield of the motor vehicle. Additionally or alternatively, the display device can be integrated or embedded or inserted in a base material of the windshield. In other words, the display device is integrated into the windshield of the motor vehicle, particularly in a base material of the windshield. “Windshield” refers particularly to a front window of the motor vehicle. Preferably, the display surface of the display device faces an environment of the motor vehicle. In other words, the display surface can face an exterior of the motor vehicle. The arrangement or integration of the display device on or in the windshield of the motor vehicle is advantageous because it reduces a breakdown susceptibility and thus increases a robustness for displaying the output data. Furthermore, readability of the output data by the display device can be increased. The integration or embedding of the display device in the base material of the windshield is further advantageous because the surface of the windshield facing the interior of the motor vehicle is designed to be smooth or flat or planar. Furthermore, the windshield can thus be cleaned in a better and easier manner. By displaying the output data by means of the display device, theft of the placard can be prevented.

It can preferably be provided that the display system also has a plurality of display devices. In other words, a use of a plurality of display devices can be provided. The plurality of display devices can be arranged in different regions of the windshield. The respective display devices can be designed analogously to the display device already described. The positioning of the display device or the plurality of display devices can be predetermined or stipulated, for example, by a legal situation.

Advantageously, the display system further comprises a heating element which is designed to heat the display device. For example, the heating element can be designed as a heating wire. The heating element can be integrated into a frame of the display device. Preferably, the frame surrounds or encircles or frames the display surface of the display device. If the windshield is coated or covered, e.g., with ice or frost or condensate, it can be ensured that, due to the heating element, the display surface can be cleared, thus ensuring a readability or visibility of the output data.

An advantageous development provides that the detection device is further designed to detect an ambient temperature in an environment of the motor vehicle, wherein the control device is designed to only actuate the heating element for heating the display device when a detected value of the ambient temperature lies below a predetermined threshold value. The detection device can comprise, for example, a thermometer which is designed to detect or measure the temperatures in the environment of the motor vehicle. Alternatively, the detection device can receive temperature data from a weather station. The predetermined threshold value can be between −5° C. and 5° C., preferably 0° C. For example, if the ambient temperatures fall below the freezing mark, the windshield can freeze, obstructing a readability of the display device. Due to the heating element, it can be ensured that the display device remains visible even at low ambient temperatures.

The application also includes the combinations of the described embodiments.

The application also includes developments of the method according to the application, which include features already described in connection with the developments of the method according to the application or the display system according to the application. For this reason, the corresponding developments of the method according to the application or the display system according to the application are not described herein again.

In the following, embodiments of the invention shall be described. In the drawings:

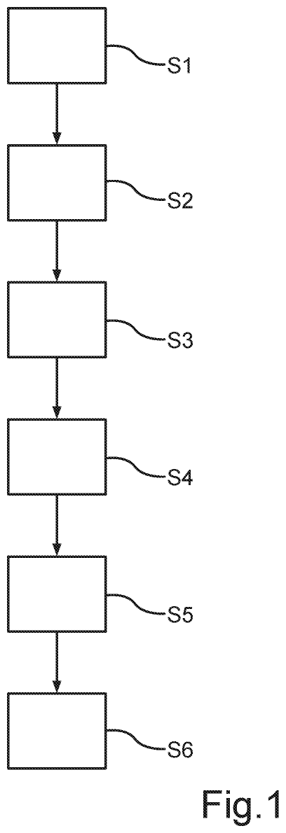

FIG. 1 shows a schematic depiction of a method for displaying output data in a flow chart;

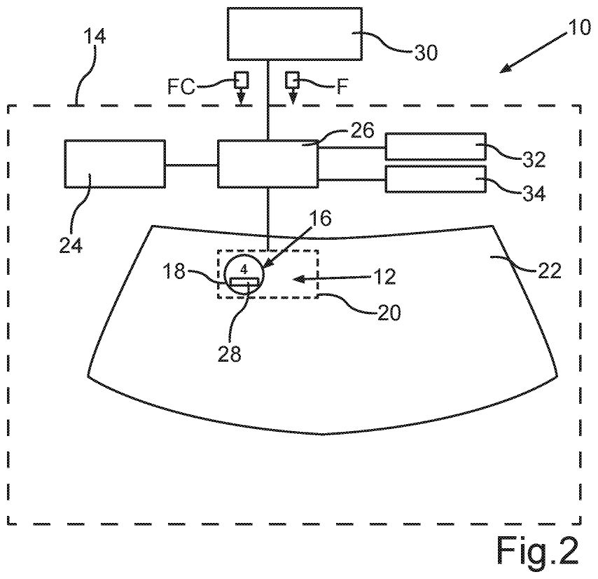

FIG. 2 shows a schematic depiction of a display system for displaying the output data; and

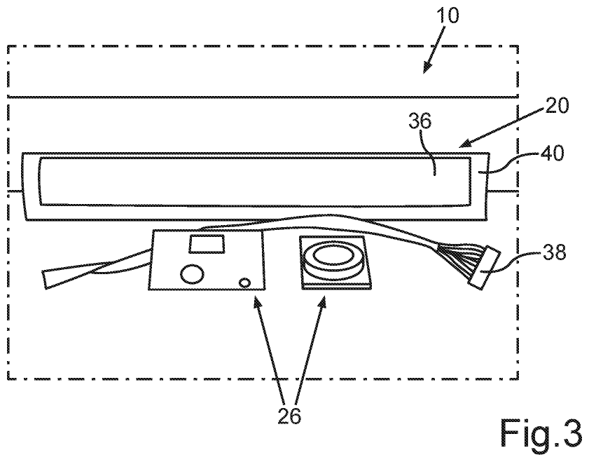

FIG. 3 shows a schematic depiction of individual components of the display system.

The embodiments described below are preferred embodiments of the invention. In the embodiments, the described components of the embodiments each constitute individual features of the application to be considered in isolation, which individually also develop the application in isolation and are thus also to be considered to be a part of the application both individually or in a combination different from the combination described. In addition, the embodiments described can also be supplemented by further features of the application which have already been described.

In the drawings, functionally identical elements are denoted with the same reference signs.

In connection with FIG. 1 and FIG. 2, the method and the display system 10 for displaying output data 12 shall be described in more detail.

In the method for displaying output data 12, the output data 12 includes motor-vehicle-side data of a motor vehicle 14. The motor vehicle 14 is preferably designed as a car, particularly a passenger car. The motor-vehicle-side data is displayed or represented by a placard 16.

As can be seen in FIG. 2, the placard 16 has a predetermined shape, particularly a round shape. “Predetermined shape” refers particularly to a basic shape of the placard 16. The placard 16 is used to link the motor-vehicle-side data. For this purpose, the motor-vehicle-side data is represented by a color coding of the placard 16 and approval data of the motor vehicle 14. “Color coding” indicates particularly that a placard surface 18 of the placard 16 is at least partially, i.e., completely or partially, filled with a color. In other words, the placard 16 can have a predetermined color. The approval data of the motor vehicle 14 includes particularly a license plate of the motor vehicle 14.

In a first method step S1 of the method, a display device 20 is initially provided for displaying or outputting the output data 12. For this purpose, the display device 20 is arranged on a windshield 22 of the motor vehicle 14. Preferably, the display device 20 is integrated into the windshield 22 of the motor vehicle 14. In this case, the display device 20 is arranged in a predetermined region of the windshield 22 of the motor vehicle 14. The display device 20 can be designed, for example, as an electronic paper, particularly as an LCD (liquid crystal display). The display device 20 is designed to display the placard 16 by superimposing pixels.

If the display device 20 is arranged on the windshield 22, the placard 16 can at first be displayed on the display device 20 as a standard placard, particularly blank and/or without color coding. In a further method step S2, the motor-vehicle-side data of the motor vehicle 14 is detected by means of a detection device 24. In this case, emission values of the motor vehicle 14 and/or the approval data of the motor vehicle 14 are detected as the motor-vehicle-side data of the motor vehicle 14. Preferably, values of an exhaust emission of the motor vehicle 14 are determined as the emission values of the motor vehicle 14. The placard 16 is thus designed particularly as an environmental placard.

If the emission values are detected by the detection device 24 of the motor vehicle 14, a control device 26 of the motor vehicle can be designed to assign the emission values to a predetermined value interval, for example, an emission class or an emission group. The color coding of the placard 16 differs on the basis of the value interval assigned to the detected emission values of the motor vehicle 14. The emission values are preferably subdivided into three emission classes. Each emission class is preferably assigned a predetermined color. For example, the placard 16 is given a green color if the emission values fall into emission class 4, a yellow color if the emission values fall into emission class 3, or a red color if the emission values fall into emission class 2. In addition to the color coding, the emission class, particularly in the form of a number or digit, can also be displayed or superimposed in a predetermined region of the placard surface 18. As can be seen in FIG. 2, the emission values of the motor vehicle 14 have been assigned to emission class 4.

In a further method step S3, the color coding of the placard 16 is determined by means of the control device 26 on the basis of the detected motor-vehicle-side data. For that purpose, the color coding is assigned to the detected emission values. In a subsequent method step S4, the placard surface 18 of the placard 16, which has the color coding, is displayed. As can be seen in FIG. 2, the placard 16 of the motor vehicle 14 shows emission class 4. With the emission class 4, the placard 16 has a green color coding. For displaying the approval data of the motor vehicle 14, a release signal F is received in a method step S5, whereupon the approval data is displayed or superimposed in a predetermined region 28 of the placard surface 18 of the placard 16. The approval data can also be detected by the detection device 24. For example, the approval data can be detected by a camera of the detection device 24. Alternatively, the control device 26 can be designed to receive the approval data.

Method steps S2 to S5 can preferably be executed during an end-of-tape check. The end-of-tape check is necessary to ensure operational safety of the motor vehicle 14, particularly of the detection device 24 and the control device 26. During the end-of-tape check, the detection device 24 and the control device of the motor vehicle 14 are checked. The detection device 24 includes one or more lambda probes, which determine or measure the emission values of the motor vehicle 14. By means of the check, the motor-vehicle-side data, at least the emission values of the motor vehicle 14, can already be determined during the end-of-tape check, and the color coding of the placard 16 can be derived therefrom. If the motor vehicle 14 is provided at the end of the end-of-tape check, only the display of the approval data of the motor vehicle 14 is missing on the placard 16.

For displaying the approval data, the owner of the motor vehicle 14 must request the approval data, particularly if the motor vehicle 14 has not yet been registered. The approval data is displayed after receiving the release signal F. The release signal F is received after entering a release code FC. In this case, the release signal F is output by a server device 30, particularly a vehicle-external server device, in response to the input of the release code FC. The server device 30 is preferably a server device of a registration office and/or a technical control board, such as the German Technical Control Board (TÜV).

For example, the owner of the motor vehicle 14 receives the release code FC directly from the registration office. For this purpose, the owner of the motor vehicle 14 can pick up the release code FC or, for example, request it from the server device 30 by means of an input device 32, which has particularly a user interface. If, for example, the release code FC is requested from the server device 30, the release code FC can be issued or provided by the server device 30. For example, the server device 30 can be designed to transmit the release code FC to a portable mobile terminal of the user, particularly via a radio link, or to the input device 32 of the motor vehicle 14. If the owner is provided with the release code FC, said owner can enter or type the release code FC, for example, into the input device 32 of the motor vehicle 14 via the user interface. Subsequently, the control device 26 of the motor vehicle 14, which is coupled particularly to the input device 32 of the motor vehicle 14, can be designed to output a signal to the server device 30, which is designed to verify the entered release code FC. If the release code FC corresponds, for example, to a release code assigned particularly to the motor vehicle 14 and stored in the server device 30, the server device 30 can output the release signal F. The “release code” is particularly a number and/or letter combination. Preferably, the release code FC is temporally limited. In other words, the validity of the release code can be limited temporally.

In order for the approval data to be displayed on the placard surface 18, the owner of the motor vehicle 14 can drive to a registration office and request the release code FC. If the user enters the release code FC in the input device 32, the release signal F for displaying the approval data of the motor vehicle in the predetermined region 28 of the placard surface 18 is output by the server device 30. The release code FC and/or the release signal F can be communicated or transmitted from the server device 30 to the control device 26 of the motor vehicle 14 via a radio link, particularly via a mobile phone connection and/or a WLAN connection and/or a Bluetooth connection. The request message from the control device 26 can also be output or transmitted via the radio link.

In a further method step S6, a timeliness, i.e., a current status, of the motor-vehicle-side data is determined. For example, the control device 26 can be designed to verify the motor-vehicle-side data at predetermined time intervals. If the motor-vehicle-side data changes, the display device 20 is actuated by the control device 26. As a result, the display device 20 can be updated by the control device 26.

In order to update the placard 16, the control device 26 can, for example, actuate an output device 34 of the motor vehicle 14, which is designed to issue a notification. The change of the motor-vehicle-side data can be detected by the control device 26. If, for example, it is determined by the control device 26 that the emission values of the motor vehicle 14, to which a color coding is assigned, change in such a way that the color coding would change, the control device 26 can be designed to actuate the output device 34. In other words, the control device 26 can be designed to actuate the output device 34 such that information is output by means of the output device 34, which indicates a change in the motor-vehicle-side data. If, for example, it is determined by the control device 26 that the approval data, such as the license plate of the motor vehicle 14, changes, the control device 26 can be designed to actuate the output device 34. In other words, the control device 26 can actuate the output device 34 in case of a license plate change of the motor vehicle 14. For example, the output device 34 can be designed as a multimedia device of the motor vehicle 14, which, for example, comprises a screen or a display or a loudspeaker. For example, a lettering can be displayed by means of the display of the output device 34. For example, this lettering can display “Change of approval data or emission values” or “New placard” or “Placard invalid.”

In order to update the color coding of the placard 16 and/or the approval data, an update code can be requested. For example, the update code can be requested by the control device 26 from the server device 30. Preferably, the control device 26 can be designed to output an update message to the server device 30 upon detection of the change in the motor-vehicle-side data. As a response to the update message, the server device 30 can subsequently be designed to output the update code, which is preferably limited temporally, or to transmit it to the motor vehicle 14 or the control device 26.

In addition to the placard 16, the display device 20 can further be designed to also display a vignette and/or a parking pass and/or a parking clock. In other words, in addition to the placard 16, a vignette and/or a parking pass and/or a parking clock can be superimposed on a display surface 36 of the display device 20.

In the following, a concrete embodiment with regard to the vignette shall be described:

For displaying the vignette, a current position of the motor vehicle 14 and/or a predetermined travel route of the motor vehicle 14 can be detected by the detection device 24 which includes, for example, a GPS tracker and/or a navigation system. Depending on the current position of the motor vehicle 14 and/or a predetermined travel route of the motor vehicle 14, a further release code for displaying the vignette can be requested, for example, from the server device 30. The vignette is displayed as soon as the further release code is received or entered via a user interface of the input device 32. Depending on the current position and/or the predetermined travel route of the motor vehicle 14, the control device 26 can be designed to actuate the display device 20 to display the vignette. For this purpose, one or more vignettes, which are assigned to the corresponding countries, can be stored in the control device 26, particularly in a memory of the control device 26. In order to activate the corresponding vignette, the control device 26 can be designed to detect the further release code. If the motor vehicle is located at or approaches, particularly during operation of the motor vehicle 14, a predetermined route section, in which a vignette is obligatory, the corresponding vignette can be displayed by means of the display device 20. For this purpose, the further release code can be entered. In addition, it can be provided that the further release code is limited temporally.

FIG. 3 shows the technical components or elements or individual parts of the display system 10. The display system 10 includes the display device 20 having the display surface 36. Furthermore, the display system 10 includes the control device 26, which is designed particularly as a control unit, for example, as an ECU (electronic control unit). The display system 10 further includes a connecting element 38, which is particularly designed as a cable with a plug connection. The connecting element 38 is designed to connect the display device 20 to the control device 26, particularly electrically and/or for signaling purposes. The display system 10 can further include a heating element, which is designed, for example, as a heating wire. The heating element can be integrated or incorporated in a frame 40 of the display element 36. The heating element is designed to heat the display device 20. For this purpose, the detection device 24, which comprises, for example, a thermometer, is further designed to detect an ambient temperature, particularly in an environment of the motor vehicle 14. The control device 26, which is coupled to the detection device 24, can be designed to only actuate the heating element for heating the display device 20 when a detected value of the ambient temperature lies below a predetermined threshold value. For example, if the ambient temperatures fall below the freezing mark, the windshield 22 can freeze, obstructing a readability of the display device 20.

Overall, the examples show how, due to the application, a display device can be integrated into the windshield and is individually programmable with respect to color and/or text and/or layout.

Preferably, a plausibility check of the motor-vehicle-side data or vehicle data is performed, particularly of the emission key number with the software statuses of the drive train and an automatic color coding of a, particularly factory-set standard, color-neutral standard placard in a display module or a display device integrated into the windshield. The color activation and the determination take place in the course of the end-of-tape check. Additionally or alternatively, an online allocation and/or activation of the associated vehicle registration number of the motor-vehicle-side data, particularly via various authorities, such as a registration office or technical control boards, can be executed via a standardized interface in the diagnostic tool of the vehicle, for example, via an interface integration in the engine control unit. The data exchange can take place via WLAN or Bluetooth on the basis of the vehicle identification number in the access region or via a temporary code number, particularly a release code. In case of an online application regarding the mailing of the temporary code number, said temporary code number can be entered once manually by the vehicle keeper or owner into a menu of the onboard computer, i.e., an input device of the motor vehicle, and the vehicle registration number can subsequently be activated independently.

A vehicle identification number and/or a chassis number and/or an emission key number and/or an engine type, particularly diesel or Otto or g-tron or e-tron or h-tron, and/or a vehicle design and/or a first registration and/or a current date can be detected as motor-vehicle-side data, particularly for displaying the placard. Additionally or alternatively, the motor-vehicle-side data can be transmitted to the server device, particularly for obtaining the release code.

1.-12. (canceled)

13. A method for displaying output data, wherein the output data includes motor-vehicle-side data of a motor vehicle that is represented by a color coding of a placard and approval data of the motor vehicle, the method comprising:
detecting, by a detection device, the motor-vehicle-side data of the motor vehicle;
determining, by a control device, the color coding of the placard based on the motor-vehicle-side data;
displaying, by a display device, the color coding in a placard surface of the placard in a display region of a display surface of the display device;
receiving, by the control device, a release signal for displaying the approval data;
displaying, by the display device, the approval data in a predetermined region of the placard surface of the placard; and
outputting, by an output device, a notification in case of a change of the motor-vehicle-side data.

14. The method according to claim 13, wherein the motor-vehicle-side data includes emission values of the motor vehicle.

15. The method according to claim 14, wherein the color coding of the placard differs based on the detected emission values of the motor vehicle.

16. The method according to claims 13, further comprising displaying a license plate number as the approval data of the motor vehicle.

17. The method according to claim 13, wherein receiving the release signal is after inputting a release code which is limited temporally.

18. The method according to claim 13, wherein the output data further includes a vignette or a parking pass or a parking clock which is displayed in a further display region of the display surface of the display device.

19. The method according to claim 18, further comprising:
detecting, by the detection device, a current position or a predetermined travel route of the motor vehicle;
requesting, by the control device, a further release code for displaying the vignette based on the current position or a predetermined travel route of the motor vehicle; and
displaying, by the display device, the vignette after the further release code is received or entered via a user interface.

20. The method according to claim 13, wherein receiving the release signal is via a radio link, the radio link including a mobile phone connection or a WLAN connection or a Bluetooth connection.

21. A display system for displaying output data, wherein the output data includes motor-vehicle-side data of a motor vehicle which is represented by a color coding of a placard and approval data of the motor vehicle, the display system comprising:
a detection device configured to detect the motor-vehicle-side data of the motor vehicle;
a control device configured to:
determine the color coding of the placard based on the motor-vehicle-side data;
receive a release signal for displaying the approval data in a predetermined region of the placard surface of the placard;
actuate a display device for displaying the color coding and the approval data in the placard;
actuate an output device to output a notification when the control device detects a change of the motor-vehicle-side data;
the display device configured to:
display the output data; and
display the color coding in a placard surface of the placard in a display region of a display surface of the display device;

22. The display system according to claim 21, wherein the display device is arranged in a predetermined region of a windshield of the motor vehicle or integrated in a base material of the windshield.

23. The display system according to claim 21, further comprising a heating element that is configured to heat the display device.

24. The display system according to claim 23, wherein the detection device is further configured to detect an ambient temperature in an environment of the motor vehicle, wherein the control device is further configured to actuate the heating element for heating the display device when a detected value of the ambient temperature lies below a predetermined threshold value.
